(19) United States
(12) Patent Application Publication
(10) Pub. No.: US 2017/0243470 A1
(43) Pub. Date: Aug. 24, 2017

(54) An electronic alerting system and a method for the same

(71) Applicant: Innolion Oy, Tampere (FI)

(72) Inventor: Olli Säynätmäki, Tampere (FI)

(73) Assignee: Innolion Oy, Tampere (FI)

(21) Appl. No.: 15/328,606

(22) PCT Filed: May 24, 2013
(86) PCT No.: PCT/FI2013/050570

§ 371 Date: Jan. 24, 2017

(30) Foreign Application Priority Data
May 25, 2012 (FI) 20125558

(51) Int. Cl. G08B 25/01; G08B 21/02; G06F 19/00

(52) U.S. Cl. CPC G08B 25/016; G06F 19/3418; G08B 21/02

(57) ABSTRACT

This invention concerns an electronic alerting system and a method for the same. The method comprises receiving data from a client device, wherein a user of the client device has a profile data stored in a server; and wherein the data comprises at least a location information of the client device; determining whether the data relates to an emergency; and if so routing an alarm to a group of contact persons, which are related to the profile data; determining location of each contact person having provided an accepting response to said alarm; creating information comprising at least the determined locations; and providing said information at least to the client device.

### FIELD OF THE INVENTION

The present invention relates to an electronic alerting system and a method for the same.

### BACKGROUND OF THE INVENTION

There are times when people need additional measures to increase their feeling of safety. At that time, people are more dependent on external and outsourced aid services (e.g. visiting nursing service) or their closed ones, and need an effective way to call help. Elders living at home by themselves, children expanding their playing area, anyone having a certain disease that requires additional care and/or timed medication—these are examples of groups that benefit from assisted alerting system to alert for example their family, relatives, nurses or volunteers in case of emergency.

There are electronic alerting systems on the market, which are based e.g. on personal monitoring device configured to make an alarm, when a certain situation on a patient or a user is met. The alarm is delivered to one or more persons, who can check what is the problem. These systems typically operate with a predetermined medical monitor and has been tailored for this medical monitor.

There is, therefore, a need for a solution that does not need to be customized for single monitor's or sensor's needs, but is able to easily adapt to various situations where different kind of sensors are used, or to use only such data that is available on a mobile terminal.

### SUMMARY OF THE INVENTION

Now there has been invented an improved method and technical equipment implementing the method, by which the above problems are alleviated. Various aspects of the invention include a method, a client device, a server, an alerting system and a computer readable medium comprising a computer program stored therein, which are characterized by what is stated in the independent claims. Various embodiments of the invention are disclosed in the dependent claims.

According to a first aspect a method for alerting system comprises storing a plurality of client profiles in at least one server, wherein each client profile is linked to one or more other client profiles; receiving data from a client device, wherein a user of said client device has a client profile and wherein the received data comprises at least a location information of said client device; determining whether the received data relates to an emergency; and if so treating the linked client profiles for the client profile of the user in question as contact profiles; routing an alarm to users of selected contact profiles; determining locations of users of the selected contact profiles having provided an accepting response to said routed alarm; providing information at least on the determined locations at least to said client device; and if any of the locations is changed, informing the other users on the new location.

According to a second aspect a client device comprises a processor, memory including computer program code, the memory and the computer program code configured to, with the processor, cause the client device to perform at least the following: receiving data from one or more sensors; sending said data to a server, said server storing a plurality of client profiles in at least one server, wherein each client profile is linked to one or more other client profiles, wherein one of the client profiles is for a user of said client device, and said data comprising at least location information of said client device; if the data is configured to cause an alarm, the client device is configured to receive status information of such users having client profiles being linked to the client profile of the user and location information of such users having client profiles being linked to the client profile of the user and whose status information relates to an accepting response.

According to a third aspect, a server comprises a processor, memory including computer program code, the memory and the computer program code configured to, with the processor, cause the server to perform at least the following: storing a plurality of client profiles in at least one server, wherein each client profile is linked to one or more other client profiles; receiving data from a client device, wherein a user of said client device has a client profile; and wherein the received data comprises at least a location information of said client device; determining whether the received data relates to an emergency; and if so treating the linked client profiles for the client profile of the user in question as contact profiles; routing an alarm to users of selected contact profiles; determining locations of users of the selected contact profiles having provided an accepting response to said routed alarm; providing information at least on the determined locations at least to said client device; and if any of the locations is changed, informig the other users on the new location.

According to a fourth embodiment, the alerting system comprises a client device and a server, wherein said client device comprises a processor and memory including computer program code, and wherein said server comprises a processor and memory including computer program code, wherein the cooperation of the client device and the server causes the alerting system to perform at least the following: receiving data from one or more sensors by the client device, transmitting said data with at least a location information of said client device to said at least one server, said server storing a plurality of client profiles, wherein each client profile is linked to one or more other client profiles; determining whether the received data relates to an emergency; and if so treating the linked client profiles for the client profile of the user in question as contact profiles; routing an alarm to users of selected contact profiles; determining locations of users of the selected contact profiles having provided an accepting response to said routed alarm; providing information at least on the determined locations at least to said client device; and if any of the locations is changed, informing the other users of the new location.

According to a fifth embodiment, a computer-readable medium encoded with instructions that, when executed by a computer, perform: storing a plurality of client profiles in at least one server, wherein each client profile is linked to one or more other client profiles; receiving data from a client device, wherein a user of said client device has a client profile; and wherein the received data comprises at least a location information of said client device; determining whether the received data relates to an emergency; and if so treating the linked client profiles for the client profile of the user in question as contact profiles; routing an alarm to users of selected contact profiles; determining locations of users of the selected contact profiles having provided an accepting response to said routed alarm; providing information at least on the determined locations at least to said client device; and if any of the locations is changed, informing the other users on the new location.

According to an embodiment, statuses of the contact persons are determined according to their responses to said alarm.

According to an embodiment, information comprising the determined locations and the determined statuses is created.

According to an embodiment, the created information is provided to said group of contact persons.

According to an embodiment, the contact profiles are selected according to an alerting profile or a location of the corresponding user.

According to an embodiment, the data from the client device is received in the form of an alarm.

According to an embodiment, an alarm is created on the basis of the received data.

According to an embodiment, the statuses of the contact persons are defined at least by following answers from the user of the contact profile: “accept”, “decline”; or when there is no answer from a user of the contact profile: “no answer”.

According to an embodiment, any location information is rendered to a map.

According to an embodiment, the location information of the users of the contact profiles relative to the location of the client device are provided to a list.

According to an embodiment, the information on the statuses of the contact persons are provided to a list.

According to an embodiment, the locations are updated frequently.

According to an embodiment, the location and/or status information are displayed on displays of the client device and the apparatuses of the users of contact profiles apparatus.

According to an embodiment, the data comprises data from at least one of the following: an external sensor, an external device or an internal sensor.

### DESCRIPTION OF THE DRAWINGS

In the following, various embodiments of the invention will be described in more detail with reference to the appended drawings, in which

FIG. 1 shows an embodiment of an alerting system;

FIG. 2 shows another embodiment of an alerting system;

FIG. 3 shows an example of an apparatus side method steps as a simplified flowchart;

FIG. 4 shows an example of a server side method steps as a simplified flowchart; and

FIG. 5 shows an example of a client device.

### DETAILED DESCRIPTION OF THE EMBODIMENTS

In the following, several embodiments of the invention will be described in the context of electronic alerting system. It is to be noted, however, that the invention is not limited to alerting system. In fact, the different embodiments have applications widely in any environment where data transmission concerning a state of an object is needed. In the following term “emergency” is used for describing a situation where person needs help. Literally, term “emergency” may relate to an extreme emergency, where person fights for his/her life. However, in the present disclosure, “emergency” is a general term describing any situation where a person needs help or assistance, because s/he cannot manage on his/her own.

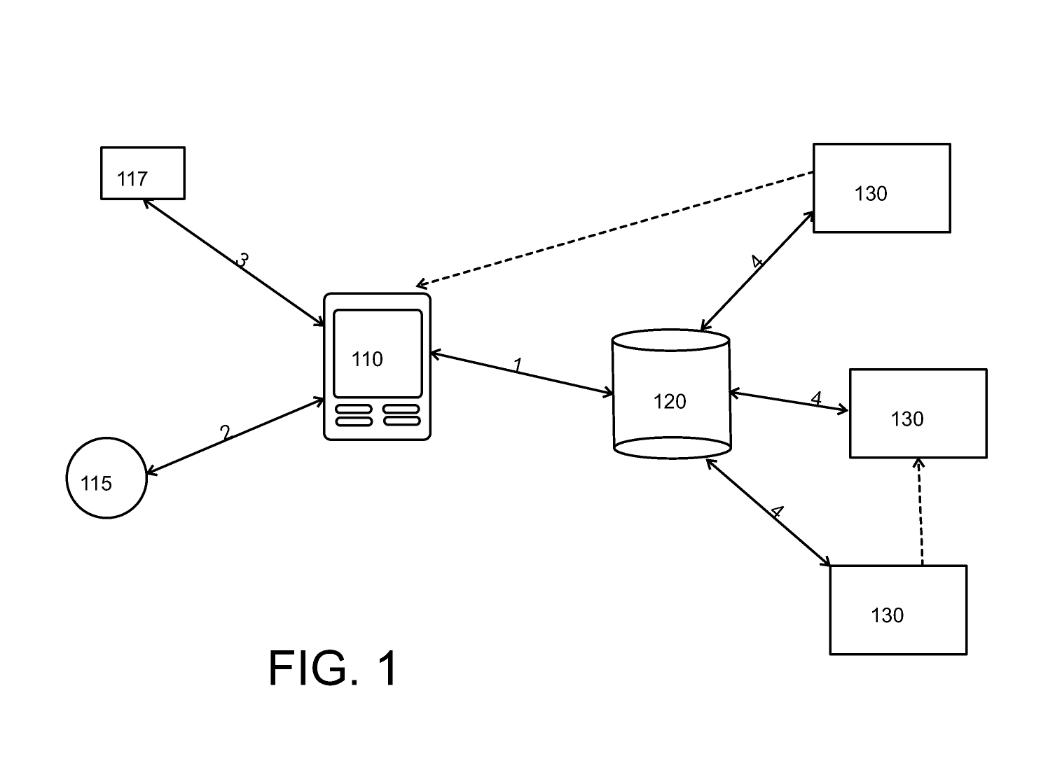

FIG. 1 shows an embodiment of an alerting system. The system comprises an apparatus 110, (i.e. a client device), being for example a handheld device, a mobile terminal, a mobile device, a smartphone, a personal computer, a laptop computer, a tablet computer, a personal digital assistant comprising software. The apparatus may comprise one or more of the following: a camera, a microphone, positioning means, e.g. a GPS (Global Positioning System), internal sensors such as e.g. an acceleration sensor, a proximity sensor, a sensor for ambient light, magnetometer, pressure sensor etc. The apparatus 110 comprises a client module of an alerting software for the purposes of the present solution. The apparatus 110 may form a connection with one or more external sensors 115. The apparatus may also form a connection with one or more external devices 117. The external sensor 115 and the external device 117 may be separate physical devices. But the external device 117 and the external sensor 115 may also be arranged into one device, whereby an apparatus 110 may form a connection with one or more such devices. An example of such device is an electrical whistle (i.e. the external device) having a push button switch (i.e. the external sensor) in the physical covering of said electrical whistle. The external sensor 115 may also be any medical sensor or non-medical sensor (e.g. alcometer or a household sensor, such as a fire-alarm or door switch) that is able to monitor the condition of a e.g. user or property. The external device 117 may also act as a central unit, to which yet other devices (not shown in figures) are connected. Such a central unit is configured to transfer data between the apparatus 110 and the devices which are connected to said central unit.

The alerting system comprises also at least one server 120, which is a computer with dedicated alerting software (i.e. server module) and comprising a data storage. The server functionality may be distributed to one or more server devices, whereby the server 120 may be considered as a server system. For example, a storage may be located in one server device and a processor may be located in another server device.

The server 120 is configured to store profile data concerning the user of the apparatus 110. In addition, the server 120 is configured to store profile data for plurality of users. The user's profile data comprises information on the user of the apparatus 110 (later called as “a target person”), and on persons relating to the user and who are automatically contacted in a case of an emergency. These persons are later called as “contact persons”. In addition, the profile data may also comprise information on user's diseases, allergies etc. but also any other information that relates to the user and his/her condition. Further, the profile data may comprise information on the target person's relationship (family (daughter, son, cousin, mother, father, . . . ), a neighbor, a nurse, etc.) to each contact person. In addition, the user may prioritize the contact persons in his/her profile, e.g. who should be contacted at least if not all, or categorize the contact persons, e.g. who should be contacted for which emergency. In some cases, the profile data may also include information on external sensors and external devices relating to the user. The user may add or delete or change any information in the profile data by his/her apparatus or by a different computer device via e.g. a web user interface. It is also possible to request another person to make modifications to the profile data.

Also contact persons have profiles in the server 120. The profile data of the contact person may include all or some of the elements that are defined in the target person's profile. However, at least contact information (at least one of the following group: telephone number, email, ID for internet calls, etc.) should be included in contact person's profile. Further, the profile data of the contact person may contain any other useful information concerning the contact person. The profile data may also contain some information on how/when/where a contact person can be contacted, i.e. alerting profile. The alerting profile defines when he/she can be alerted, e.g. based on the day, the time of the day or distance to the scene. In addition to this information, any other information that can be seen to complete the profile data may be included in the profile of both target and contact persons.

From the server's point of view, the profiles stored in the server may be handled as “client profiles”, which means that categorizing profiles to “target” or “contact” persons is not necessary. Therefore, a role of a single person (target or contact) having a client profile in the server's database depends on the situation. This means that the client profiles may be equal, but it is the emergency situation that creates “contact persons” for a profile in question. Therefore a user may be a plain user until s/he is confronted with an emergency situation. At that point, such a user's client profile is processed as a profile of a target person as a result of which, the linked persons for said profile are turned to contact persons. When the emergency is over, all the profiles are returned to equal client profiles until a new emergency takes place. However, the classification to target and contact persons in this disclosure is made for understanding purposes. Nevertheless, it is still possible to classify profiles in the server into more than one group, if needed.

The user may add contact persons to his/her profile by sending a message to each contact person directly or via the server, which message asks whether the person would like to become a contact person in case of emergency for the user. If the contact person accepts the request, the contact person automatically registers him/herself to the alerting system and a profile is created for him/her. In addition, the target user's profile data is linked to this new profile. The server also may inform the user that a new contact person has been added to the profile data. The profile data may be modified or input and new profiles may be created via e.g. web user interface. In addition, any linkage to a certain user profile can be reversed by any person that is related to the profile data, by the user him/herself or by a person having editing rights to the profile.

The client profiles are user-based, whereby they can be used by different devices of the user. For example, if the user buys a new apparatus, and if the apparatus doesn't have the client module of the alerting software, it needs to be installed in order to have the needed profile data synchronized to this new device.

The server is able to connect to a remote terminal 130, which is an apparatus of a contact person. In such a case, where profile data comprises more than one contact person, the server is able to form a connection to all of them. One contact can also have several ways to be contacted, e.g. SMS or push message to a mobile phone, or email which can be read from several devices. FIG. 1 illustrates a situation, where the server is connected to three contact persons, each having a terminal 130. The remote terminal 130 is a computerized device with a dedicated piece of alerting software or a generic software (e.g. web browser) capable of showing the alerting situation/status generated by the server. Examples of such a devices are for example a handheld device, a mobile terminal, a mobile device, a smartphone, a personal computer, a laptop computer, a tablet computer, a personal digital assistant comprising software.

As shown in FIG. 1, the remote terminal 130 may communicate with another remote terminal 130 or with the apparatus 110.

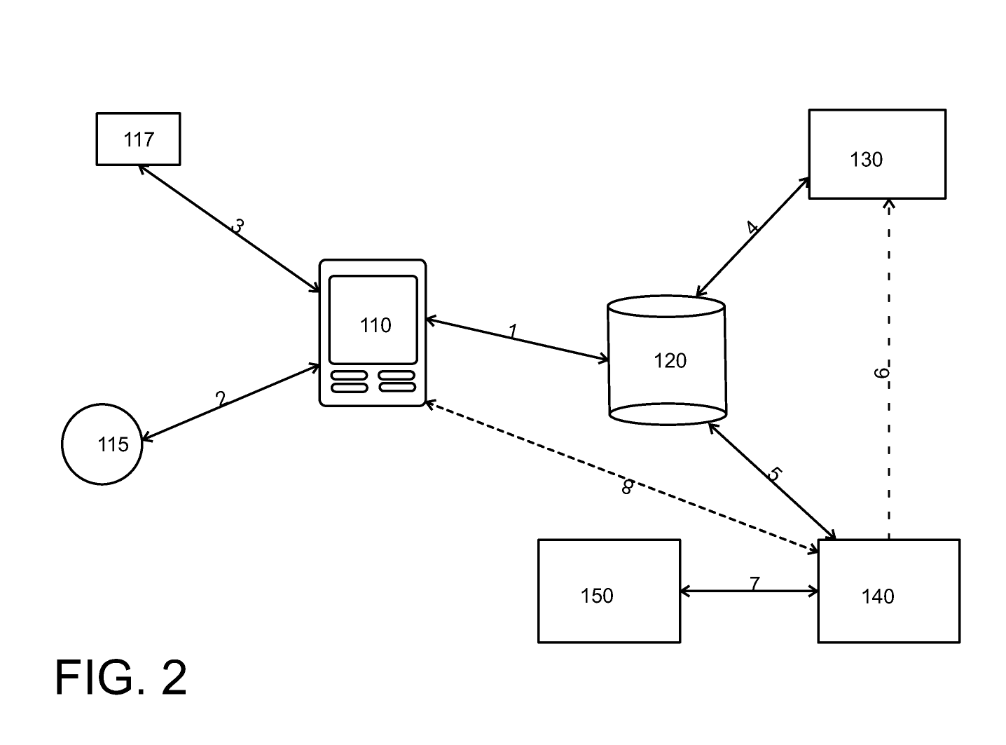

FIG. 2 shows another embodiment of the alerting system. In this embodiment the system additionally comprises a local terminal 140, that is connected to or incorporated with the server 120. The local terminal 140 may be a computerized device, e.g. a handheld device, a mobile terminal, a mobile device, a smartphone, a personal computer, a laptop computer, a tablet computer, a personal digital assistant, with a dedicated piece of alerting software or a generic software (e.g. web browser) capable of showing the alerting situation/status generated by the server. The local terminal 140 may be a computer device or system being hosted by a third party, e.g. a service center. The local terminal 140 is used by a monitoring person, who may monitor the traffic between the apparatus 110 and the server 120 but who especially reacts the alerts occurring in the server. In this example, the monitoring person is able to see, how many contact persons (i.e. remote terminals) are successfully contacted, or whether professional help from e.g. security service or medical service is needed. The monitoring person with the local terminal 140 is able to instruct 6 the contact persons, but also to command or guide 7 the professionals via their communication devices 150. For example, if none of the contact persons is able to help the target person, the monitoring person can instruct the professional to assist the target person. Yet further, the monitoring person may be in contact 8 with the target person.

The previous examples have been described in such a manner that in the first example, the system operates without the monitoring person, and in the second example, the system operates with the monitoring person. These examples relate to two operating modes of the system. The first example mainly utilizes acquaintances and family as contact persons, but the second example is targeted to bought professional services. In the second example, there may be only one contact person in the client profile of the user, which defines a certain service, e.g. a security service or visiting nursing service, whereby no other contact persons are necessarily needed. The actual persons in such a service, which are being contacted, are defined by the monitoring person, or by the server. However, in addition to such one service, it is possible to define also one or more contact persons in the profile.

The components 110, 115, 117, 120, 130, 140, 150 may be connected to each other by a communication network. The communication network can be any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The apparatus 110 is configured to sense its environment by obtaining data from its internal sensors. In addition to the data being obtained from its internal sensors, also other data being stored in the apparatus 110 (the data may e.g. relate to the state of the apparatus) is obtained. The apparatus 110 may also obtain 2 data from one or more external sensors 115 that are configured to sense their environment. The apparatus 110 may also obtain data 3 from one or more external devices 117, or the apparatus may control and/or transmit data from its memory by means of the communication network to such devices. The data obtained by the apparatus 110 from several sources may be processed at least partly and sent 1 to the server 120 via the communication network or data from the server can be used to control the external devices

The server 120 is configured to receive the processed and/or unprocessed data from the apparatus 110, which data with a timestamp the server 120 stores to its data storage as an event log. The received data causes an alarm in the server when predetermined conditions relating to the received data are met. For example, the data may already be in the form of alarm, or the server detects that the received data relates to an alarm, or the monitoring person detects that the received data relates to an alarm etc.) The alarm is automatically and directly sent to contact persons at their terminals 130. The remote terminal 130 may, in certain cases, have an access to the data storage of the server 120 via communication network. The alarm is stored in the server so that even if the target person's apparatus was closed, the alarm is still open in the server until it is being deactivated.

When the local terminal 140 is involved (FIG. 2), the alarm is also sent to it. As said, the local terminal 140 may operate as a monitoring terminal and can use 5 the data being stored in the server 120 via the communication network. The local terminal 140 may also manage the server's 120 data storage and route 6 the data or route access to the data from the server 120 to another local terminal or remote terminal 130. The local terminal 140 can be used for monitoring all the traffic occurring in the alerting system by e.g. a security or nursing service.

The operation of the system is described by the following example use case. The apparatus 110 communicates with the external device 117, in this example with an electrical whistle having a push button switch (representing the external sensor 115) via wireless network (based on e.g. Bluetooth technology). The apparatus 110 may transmit and receive information with both the external device 117 and the external sensor 115 separately. The alerting software in the apparatus can operate, e.g. on three operating modes: “on”, “cautious” and “alarm”, from which the operation of the apparatus depends. On the first mode “on”, the apparatus is configured to listen certain sensors, save and/or process the data in the apparatus 110 and/or optionally to send user's location and/or selected sensor data to the server. The location may be sent to the server within periods that have been defined in system's settings. On the mode “cautious”, the alerting software is activated by the user (e.g. when the user feels him/herself unsecure) or by the apparatus (e.g. in a certain location or area, or when the heart rate increases or some other condition or pattern is met) or by the server (for example after noticing from the transmitted location data that the user is in a dangerous area). In this mode, the user's location data may be defined more accurately and sent more frequently to the server. In the third mode, the alarm has been made by the user, by the apparatus or by the server. The alarm is sent to the contact persons automatically by the server. User's location data is sent and stored even more frequently. Also, a conference call or point-to-point call may be initiated between the target person and the contact persons. Instead of the three operating modes, there may be one, two or more than three operating modes.

In the previous, it has been described that target person's location is sent to the server. However, because a location can be defined by the location of the apparatus, the “location of user” is actually “location of the apparatus”. Such an interpretation should be used throughout this application.

The apparatus 110 is also connected to the server 120. The communication network between the apparatus 110 and the server 120 may be a packet-switched network. The apparatus 110 is configured to send data to the server 120, but in some cases the server 120 may ask the apparatus 110 to provide the data from its sensors or memory. The server 120 may also send information to the apparatus 110 in the form of e.g. text messages, instant messages or email. The contact persons being defined in the client profile are contacted via remote terminals 130. Monitoring device, i.e. the local terminal 140, can use the data being stored in the server either in real-time (except the transmission delays) or later. This data, or links to the data can be routed to other local terminals or to the devices 150 of professional helpers or to remote systems.

When a person who has a client profile in the server 120 and an alerting software in his/her apparatus 110 is confronted e.g. with a threatening situation, s/he may activate the alerting functionality. The alerting functionality can be activated by the target person, e.g. manually by pressing a button or an icon/a widget on a touch screen of the apparatus, by selecting the functionality by means of the device keys, by a voice command, by a moving gesture or by pressing a button of an external device. In the “on” and “cautious” mode, the functionality operates as a background functionality constantly in the apparatus, whereby the functionality may activate automatically, when receiving a certain predefined data from an external sensor, such as e.g. a cardiac sensor, a blood sugar sensor, breathing sensor. Such background operation of the software is useful e.g. when the target person is in risk of having a stroke or a fit and is not able to use and activate the alerting software on his/her personal device or when a location information of the user is wanted to be stored in the server. The “Cautious” mode can prepare the actions needed for making the alarm, whereby the actual alarm can be made even more quickly. During “On” mode, the server is made aware on target person's movements, which helps e.g. in a situation where the target person disappears or is not able to make an alarm.

After activation, the alerting software begins to sense its environment and to send data relating to it by means of the internal sensors of the apparatus and/or external sensors 115 or external devices 117 being connected to the apparatus 110 according to the user settings. As a background operation the data from the sensors can be constantly received at a frequency that is defined by the user or e.g. a medical professional. In addition, the alerting software obtains data on apparatus' status or condition.

In some cases the external sensors may provide the data already in the form of alarm. For example, some medical sensors can be configured to output only deviating data (heart rate exceeds a limit, blood sugar has fell down), whereby such data is directly transmitted from the apparatus to the server and further to the contact persons. If the apparatus receives raw sensor data from any sensor, all or part of this data may be processed in the apparatus 110 to make conclusions on the target person's condition or on the apparatus.

If the apparatus is capable of making any conclusions on the sensed data, such conclusions may be directly sent to the server. The sensed data may also be transmitted to the server 120 as such, whereby the server is configured to make the conclusions on what is the status. The user may also define in which situation sensor or other data is transmitted to the server. For example, the user may wish that all the sensor data is constantly transmitted or streamed to the server, regardless whether it is “normal” data or not. Any deviating data, however, causes an alarm in the system (unless the data concerns an emergency that has already been alarmed).

In the present solution, also data concerning location of the target person who has encountered the threatening situation can be transmitted alongside with the data being obtained from the sensor(s) to the server 120. However, it is possible, that the location data is transmitted to the server constantly, e.g. in every 5, 15, 30, etc. minutes as during the “on” mode.

The server creates a notification on the alarm, which notification comprises information on the person needing help (i.e. the target person), any deduction on what is going on there, data being obtained from the sensor(s) and the location of the target person. The notification is delivered directly to one or more remote devices 130 which corresponds to the contact persons being defined in the client profile of the user of the apparatus 110 in the server 120 or to a local terminal 140 of an aiding service. When a contact person receives a notification that an emergency has occurred with a target person on a certain location, the contact person either accepts or declines the notification or does nothing. Any operations and responses of each contact person are published in the form of “status” to the other contact persons in the profile and the target person. Therefore each person mentioned in the user's profile is able to see, who has accepted the notification, who has declined the notification and who hasn't replied yet or who is already engaged in another alert of the system either as being a contact to some other target person, or as being the target person him/herself.

When a contact person accepts the notification, s/he—at the same time—automatically transmits his/her location data to the server to be published or just allows the publishing of his/her location data if the server is already aware on that (e.g. when the contact person has the alerting software operating on a background and sending the location data to the server periodically). For example, the locations of the contact persons may have already been checked by the server, if the contact persons have allowed the server to do that. In such a case, the location only needs to be published in a case of an accepted alarm.

When a plurality of contact persons accepts the notification, the locations of all such users are also published to those related to the situation (i.e. target persons and contact persons). If a contact person declines the notification, his/her location data is not published—only the status data “declined” is published. The publishing here means that the target person and each person who has received the alarm will see the locations of the accepting contact persons and the location of the target person and the statuses of each contact person. This is carried out in such a manner that each device can be configured to fetch the updated location and/or status from the server either frequently, or when the server notifies them on the data updates. Also it is possible that the status is updated substantially constantly when the device and the server are in connection to each other.

The locations can be shown in the map, or the locations of the contact persons relative to the location of the target person can be shown as a list. The purpose of such a visual indication is to provide a glance to the situation for the target person and other contacts. In addition, the visual indication helps a contact person to select him/herself e.g. based on his/her proximity to the target person, to be the one who will assist the target person. It is also possible that the system automatically selects the assisting contact person based e.g. on proximity of the contact person to the target person and/or on the personal information of a contact person in the client profile.

If none of the contact persons accepts the notification, the server may automatically contact an emergency service, or the target person or one of the contact persons (after noticing status “declined” for everyone) may contact the emergency service. If the status of all the contact persons is “not replied yet”, the server may automatically contact the emergency service after a predetermined time has elapsed. The client module of the alerting software in the apparatus 110 also shows an easy way for the target to call the emergency service, with some additional information, e.g. the location.

If the local terminal 140 operates in the system (FIG. 2) there is a person who monitors the traffic in the server and notices the alarm in the server 120. In a case of an alarm, the server arouses the monitoring person's attention and displays the data that is obtained from the target person's device. The monitoring person may interpret the information in order to solve out what kind of situation may have occurred and may contact e.g. professional guards and/or nurses, an emergency center, paramedic or similar, when needed. Also the server may automatically propose instructions or guidance to the monitoring person. The monitoring person may contact also the target person. Any person may be contacted by calling or by sending data and/or any conclusions made by the monitoring person concerning the situation.

When the accepting contact person(s) begins to move towards the target person, the location of the contact person(s) is updated frequently so that the other members and the target person will see where the contact person(s) is going and whether unexpected delays will occur and the moving towards the target slows down. In such a case the contact person approaching the target person may be changed.

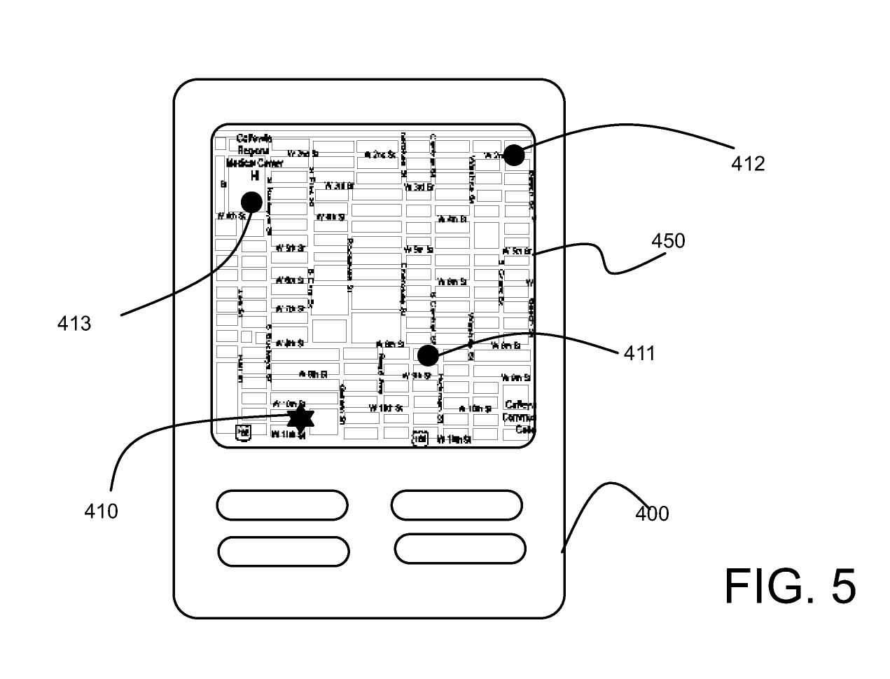

FIG. 5 shows an example of a mobile device 400 with a view 450 to a map that shows locations of the persons. The icon 410 corresponds to the target person, and the icons 411, 412, 413 correspond to the contact persons who have accepted the notification. These icons can also be used to call or message the contacts quickly. The closest contact person 411 may be blinked or otherwise highlighted. The distances to the target person may also be shown alongside with the contact person's icon 411, 412, 413. The location information may also be shown as coordinates and/or as address. The map view or status view may also comprise a quick link that can be used for calling the emergency number. The target person's (and contact person's) location accuracy can also be shown, either as a number, or visually, e.g. as a circle or a shadow. The location accuracy may vary according to the positioning method being used (see above). The contact person can also activate the possible navigation application in his mobile device, to be able to navigate to the target most efficiently, using visual routing guidance and or speech navigation.

When the contact person(s) meets the target person who has made the alarm, the contact person may deactivate the alarm. The deactivation may be done by inputting a PIN code to the software. The PIN-code is personal for each user having the client profile. Therefore, any person relating to target person's profile may use his/her own PIN code to deactivate the alarm. This means that the target person, who has made the alarm, may cancel the alarm by the his/her own PIN code before the contact person(s) reached her/him (e.g. when the threat is over or in a case of false alarm) or deactivate the alarm, when the contact person(s) has arrived to her/him. In addition to the target person, also a contact person may deactivate the alarm by his/her PIN code when s/he has arrived to the target person. If the alarm is not deactivated after a predetermined time, the server may remind the target and the contacts of the open alarm and to request whether the emergency is over.

In the embodiment of FIG. 2, the local terminal 140 may communicate with the apparatus 110 and with any remote terminals 130. The remote terminal 130 may also communicate with the apparatus 110 or with the device 150 of a professional helper. Also the professional helper 150 may communicate with the apparatus 110. Any data or voice communication between devices of the system is possible, even if not shown in the figure.

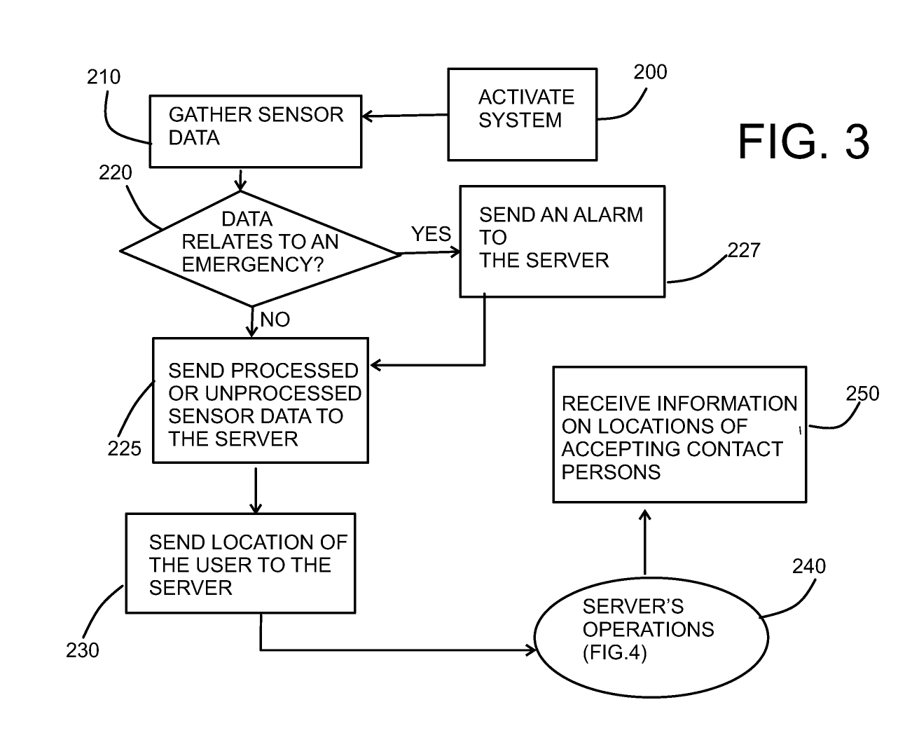

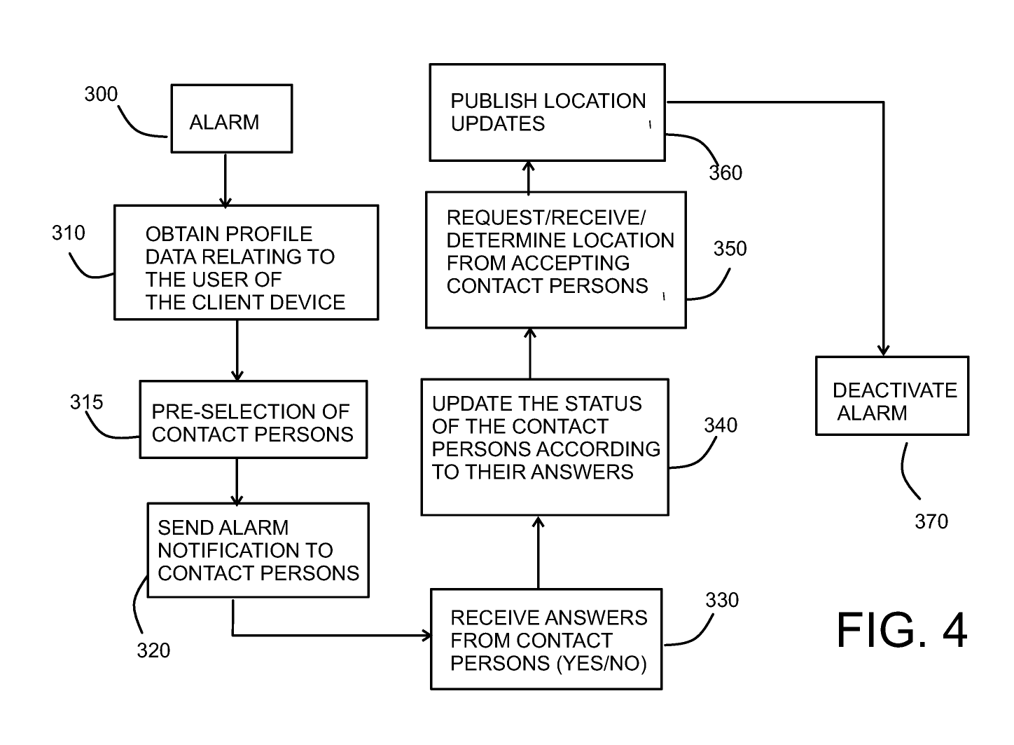

FIGS. 3 and 4 show examples of a client side method steps (FIG. 3) and a server side method steps (FIG. 4) as simplified flowcharts. The operation of the alerting software for making an alarm in the client device begins (FIG. 3), when the software is activated 200. When the software is launched, the mode is “on” and the software is operating in the background and sends location data to the server. The user may also set the mode to “cautious” or “alert”. Due to activation, the alerting software begins to gather 210 sensor data according to the user selections (which sensors, frequency etc.) and device status data (battery charge status, network coverage etc.). The sensor data may be obtained from any sensor (internal or external, or sensor data through an external device) being connected to the client device or locating within the client device. Here, the sensor data includes also data relating to client device's condition (e.g. battery charge status). The client device can define whether the data relates to an emergency 220, and if so, an alarm is made and sent to the server 227. However, in addition to the alarm, but also if the data does not relate to an emergency, the data may be transmitted 225 to the server for storage purposes. The sensor data may be processed before sending, or it may be raw sensor data. In addition to the sensor data or the alarm, also location of the target person's apparatus is sent 230 to the server. The location data is obtained from e.g. a GPS or other satellite based positioning system or other positioning means (e.g. based on network cells (e.g. Cell ID) or access points (e.g. WLAN)) of the apparatus or by an address or other type of location data being inputted by the user. The operation 240 of the system then continues on the server side according to the example of FIG. 4.

In the following, the server related operations in case of an alarm (instead of mere data storage) are described (FIG. 4). However, the local terminal may participate to some or all actions being described next. Therefore, every time “a server” is mentioned, it can be interpreted “a server and/or a local terminal”. The server receives an alarm 300 in the form of data being transmitted by the client device. Instead of receiving the alarm, the server may create an alarm 300 based on the received information. Due to the alarm, the server obtains 310 profile data relating to the target person of the client device in order to solve out the contact persons. The server may contact all the contact persons directly, or can make a pre-selection 315 of the contact persons. The pre-selection may sort out contact persons that are not close enough to the target person's location, or sort out contact persons according to their alerting profile, or sort out the contact person according to the type of the alarm. After the pre-selection, the server sends 320 a notification on the alarm to the selected contact person(s). After sending the notification, the server waits for the responses 330 from the contact persons (YES/NO). After receiving a new response from a contact person, the server is configured to update the statuses of the contact persons according to the received answer 340. Also, when a remote terminal 130 of a contact person creates an accepting response to the notification, a location of the contact person is automatically determined, requested or received 350 from such a contact person. The locations of such contact persons who have accepted the notification are published 360. The locations of the accepting person(s) are updated while they are approaching the target person. The information on the locations of the accepting contact persons are also published to the target person (see FIG. 3: 250). In addition, the target person will notice from the map or status view, who will assist the target person, for example by coming to see the target person, or ask additional help. Also the target person and the contact persons can see e.g. in a list format all the contacts that the alarm was sent and their response status (e.g. Accepted/Declined/No answer/Alarmed/Helping). In said status information “Accepted” relates to YES response, “Declined” relates to NO response, “No answer” relates to a situation, where contact person hasn't yet replied, “Alarmed” relates to a situation, where the contact person also has activated an alarm for him/her, and “Helping” if the contact person has already accepted help request from a third person. It is appreciated that the status names may vary from what has been presented here. It is also appreciated that the amount of response statuses may also vary from these five statuses. In some cases only “Accepted” and “Declined” is enough, but in some other cases there needs to be even more than five options to describe the status of the contact person.

The server's operation for processing an alarm ends, when the alarm is deactivated (FIG. 4: 370).

Yet, in another example use case the alerting software is constantly operating as a background operation in the mobile device of the target person. The alerting software obtains data from a cardiac sensor. When the alerting software receives data that corresponds to a arrhythmia, information on such a situation is immediately send as an alarm to the server. The server notices the alarm and creates a notification to be send to contact persons of the target person. The contact persons may also in this example comprise contact persons that have been identified in the profile, but also (or alternatively) contact persons being defined as a set of (medical or non-medical) volunteers that can be found e.g. by their location with respect to the target person. The contacted person either accepts or declines the notification, whereby the statuses of all contacted persons and the locations of the accepting persons are published. If some of the contacted persons do not respond to the notification, the notification can be resent after a while, and the status of such person is “No answer”.

Yet, in another example use case, a child (i.e. target person) has a mobile terminal comprising the alerting software that is constantly active. When the software receives predefined data from e.g. a GPS, the alerting software makes an alarm that is delivered to child's parents via the server. Such a situation may occur, when the child goes to the beach alone or to a public road with heavy traffic. The area causing alarm can also be determined by the parents, e.g. area not allowed is entered by the child, or there is an area that is allowed and crossing that border causes an alarm. The location of the child is transmitted to the parents via the server, and the child can receive data concerning the location of the parents, if and when one of the parents accepts the notification. Information on the location of the parents is also relieving for a child, if the child has got lost e.g. into a forest. Also, the client module of the alerting software can send an alert to one or more predetermined contacts, when there is a problem in the device status, e.g. battery is running out or the device is turned off. The server can also be set to request the device status, if there is no frequent data received from the device, and the server can create an alarm if there is no answer.

The alerting system with familiar contact persons may be expanded towards external contacts, having a volunteer contact person or a nursing service as an example. In such a solution, the volunteers' (‘or nurses’) devices are provided with an alerting application. When a target person makes an alarm, the server (or a monitoring person) automatically searches for external contacts such as volunteers (or nurses) within e.g. one kilometer radius and sends the notification to such persons. When an external contact accepts the notification, the location of the external contact can be published as described above. The external contact may not be known by the target person, but the volunteer (or a nurse) may be registered helper for all persons in certain specific or general need in a certain area. The external contacts are not therefore directly defined in the client profile, but such external contacts may be related to said profile data e.g. by their locations with respect to the location of the target person being defined in the client profile. It is also possible that external help is allowed in the profile data which is specified to correspond to e.g. a certain institute or company that provides helpers based on their criteria. Thereby, the user allows also external contacts and volunteers to help him/her. In such a case, the external contact's contact information is not specified in the user's profile, but is determined from the server's contact list.

The present solution provides great advantages compared to the existing alerting systems. For example, the present system does not require a telephone connection between persons, the system may operate also message-based using different ways of communication. In addition, in current systems the location of the target person is not followed nor stored until an alarm is received. Yet further, the monitored data is transmitted through the server (and also stored in the server) and not directly to the contact persons. What is substantially beneficial in the present solution, is that the locations of the accepting (helping) contact persons are sent to the target person who is in the emergency situation. In addition, the contact persons are able to see each other's locations and statuses as well. By this, the target person is always aware, where the contact person/s is/are, and approximately how long it would take to get help. Also, the contact persons can constantly see, who is the closest to the target person. It is appreciated that the embodiments of the present solution streamline the processes for getting right kind of help to the right place whenever needed—quickly and effortlessly. Creating help request is effortless—to the extreme, with rich information. Selecting/deciding who among the alert message recipients will act for the request is quick, based on the rich information (e.g. location and status data) about the situation. Finally, getting the help to the target person is assisted by updating the locations of the relevant persons on a map—showing the way to the spot, assuring easy delivery of the help.

Yet, the present solution comprises alerting software that is distributed not only to the target person, but also to the contact persons, but not necessarily. The contact persons may use the software to receive information concerning the emergency via different communication channels—not only via calls or short messages. However, the contact persons may also utilize a web user interface to obtain information on the alarm, without the dedicated alerting software. In some cases, the data that is transmitted within the mobile alerting system may be crypted.

The server of the present solution operates automatically so that each time an alarm is received, the location of the target person is obtained, and a notification is sent to contact persons. This does not require a presence of a monitoring person, even though it is possible.

The various embodiments of the invention can be implemented with the help of computer program code that resides in a memory and causes the relevant apparatuses to carry out the invention. For example, a terminal device (i.e. the apparatus, the local terminal and the remote terminal) may comprise circuitry and electronics for handling, receiving and transmitting data, computer program code in a memory, and a processor that, when executing the computer program code, causes the terminal device to carry out the features of an embodiment. Yet further, a network device (i.e. the server) may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1. A method for alerting system, comprising:
storing a plurality of client profiles in at least one server, wherein each client profile is linked to one or more other client profiles;
receiving data from a client device, wherein a user of said client device has a client profile and wherein the received data comprises at least a location information of said client device;
determining whether the received data relates to an emergency; and if so
treating the linked client profiles for the client profile of the user in question as contact profiles;
routing an alarm to users of selected contact profiles;
determining locations of users of the selected contact profiles having provided an accepting response to said routed alarm;
providing information at least on the determined locations at least to said client device; and
if any of the locations is changed, informing the other users on the new location.

2. The method according to claim 1, further comprising determining statuses of the users of the selected contact profiles according to their responses to said alarm.

3. The method according to claim 2, comprising creating information comprising the determined locations and the determined statuses.

4. The method according to claim 3, further comprising providing the created information to the users of the selected contact profiles.

5. The method according to claim 1, wherein the contact profiles are selected according to a location of the corresponding user.

6. (canceled)

7. (canceled)

8. (canceled)

9. The method according to claim 1, wherein any location information is rendered to a map.

10. The method according to claim 1, wherein the location information of the users of the contact profiles relative to the location of the client device are provided to a list.

11. The method according to claim 2, wherein the information on the statuses of the users of the contact profiles are provided to a list.

12. (canceled)

13. The method according to claim 4, comprising displaying location and/or status information on displays of the client device and the apparatuses (130) of the users of contact profiles.

14. The method according to claim 1, wherein the data comprises data from at least one of the following: an external sensor, an external device or an internal sensor.

15. (canceled)

16. A server comprising a processor, memory including computer program code, the memory and the computer program code configured to, with the processor, cause the server to perform at least the following:
storing a plurality of client profiles in at least one server, wherein each client profile is linked to one or more other client profiles;
receiving data from a client device, wherein a user of said client device has a client profile; and wherein the received data comprises at least a location information of said client device;
determining whether the received data relates to an emergency; and if so
treating the linked client profiles for the client profile of the user in question as contact profiles;
routing an alarm to users of selected contact profiles;
determining locations of users of the selected contact profiles having provided an accepting response to said routed alarm;
providing information at least on the determined locations at least to said client device; and
if any of the locations is changed, informing the other users on the new location.

17. The server according to claim 16, further comprising computer program code configured to, with the processor, cause the server to perform at least the following:
determining statuses of the users of the selected contact profiles according to their responses to said alarm.

18. The server according to claim 17, further comprising computer program code configured to, with the processor, cause the server to perform at least the following:
creating information comprising the determined locations and the determined statuses

19. The server according to claim 16, further comprising computer program code configured to, with the processor, cause the server to perform at least the following:
providing the created information to the users of the selected contact profiles.

20. The server according to claim 16, wherein the contact profiles are selected according to an alerting profile or a location of the corresponding user.

21. (canceled)

22. (canceled)

23. (canceled)

24. The server according to claim 16, further comprising computer program code configured to, with the processor, cause the server to perform at least the following:
rendering any location information to a map.

25. The server according claim 16, further comprising computer program code configured to, with the processor, cause the server to perform at least the following:
providing the location information of the users of the contact profiles relative to the location of the client device to a list.

26. The server according to claim 17, further comprising computer program code configured to, with the processor, cause the server to perform at least the following:
providing the information on the statuses of the users of the contact profiles to a list.

27. (canceled)

28. The server according to claim 17, further comprising computer program code configured to, with the processor, cause the server to perform at least the following:
providing location and/or status information to the displays of the client device and apparatuses of the users of contact profile.

29. (canceled)

30. (canceled)

31. A computer-readable medium encoded with instructions that, when executed by a computer, perform:
storing a plurality of client profiles in at least one server, wherein each client profile is linked to one or more other client profiles;
receiving data from a client device, wherein a user of said client device has a client profile; and wherein the received data comprises at least a location information of said client device;
determining whether the received data relates to an emergency; and if so
treating the linked client profiles for the client profile of the user in question as contact profiles;
routing an alarm to users of selected contact profiles;
determining locations of users of the selected contact profiles having provided an accepting response to said routed alarm;
providing information at least on the determined locations at least to said client device; and
if any of the locations is changed, informing the other users on the new location.
